(19) United States
(12) Patent Application Publication
(10) Pub. No.: US 2022/0328877 A1
(43) Pub. Date: Oct. 13, 2022

(54) ELECTROCHEMICAL DEVICE

(71) Applicant: Panasonic Intellectual Property Management Co., Ltd., Osaka (JP)

(72) Inventors: HIDEO SAKATA, Osaka (JP); NAO MATSUMURA, Osaka (JP); HIDEKI SHIMAMOTO, Kyoto (JP); KENICHI NAGAMITSU, Kyoto (JP); NOBUTAKA TAKEDA, Osaka (JP)

(21) Appl. No.: 17/614,352

(22) PCT Filed: Jun. 24, 2020
(86) PCT No.: PCT/JP2020/024753

§ 371 Date: Nov. 25, 2021

(30) Foreign Application Priority Data
Jun. 25, 2019 (JP) 2019-117873

(51) Int. Cl. H01M 10/0568; H01M 10/0525; H01M 4/60; H01G 11/48; H01G 11/50; H01G 11/62

(52) U.S. Cl. CPC H01M 10/0568; H01M 10/0525; H01M 4/602; H01G 11/48; H01G 11/50; H01G 11/62; H01M 2004/028

(57) ABSTRACT

An electrochemical device includes a positive electrode including a positive electrode active material, a negative electrode including a negative electrode active material, and an electrolytic solution. The positive electrode active material contains a conductive polymer, and the conductive polymer is configured to be doped and dedoped with anions. The electrolytic solution contains (a) a first salt of a lithium ion and a first anion and (b) a second salt of a lithium ion and a second anion. The first anion is a bis(sulfonyl)imide anion containing fluorine.

### TECHNICAL FIELD

The present invention relates to an electrochemical device containing a conductive polymer in a positive electrode.

### BACKGROUND

In recent years, electrochemical devices having intermediate performance between lithium ion secondary batteries and electric double-layer capacitors have been attracting attention. For example, the use of a conductive polymer as a positive electrode material has been studied (for example, PTL 1). Since the electrochemical device containing a conductive polymer as a positive electrode material is charged and discharged by adsorption (doping) and desorption (dedoping) of anions, the electrochemical device has a small reaction resistance and has higher output than output of a general lithium ion secondary battery.

### CITATION LIST

### Patent Literature

PTL 1: Unexamined Japanese Patent Publication No. 2014-35836

### SUMMARY

### Technical Problem

An electrochemical device can be charged by various methods. For example, in float charging, a constant voltage is continuously applied to the electrochemical device. Meanwhile, when a positive electrode containing a conductive polymer is used as the positive electrode active material, the capacitance decreases as the charge period becomes longer, and thus the float property tends to decrease.

### Solution to Problem

In view of the above, one aspect of the present invention relates to an electrochemical device including a positive electrode including a positive electrode active material, a negative electrode including a negative electrode active material, and an electrolytic solution, in which the positive electrode active material contains a conductive polymer, and the conductive polymer is configured to be doped and dedoped with anions. The electrolytic solution contains a first salt of a lithium ion and a first anion and a second salt of a lithium ion and a second anion, and the first anion is a bis(sulfonyl)imide anion containing fluorine.

### Advantageous Effect of Invention

According to the present invention, a decrease in float property of the electrochemical device can be suppressed.

### BRIEF DESCRIPTION OF DRAWING

FIG. 1 is a longitudinal cross-sectional view illustrating a configuration of an electrochemical device according to one exemplary embodiment of the present invention.

### DESCRIPTION OF EMBODIMENT

An electrochemical device according to the present exemplary embodiment includes a positive electrode including a positive electrode active material, a negative electrode including a negative electrode active material, and an electrolytic solution. The positive electrode active material contains a conductive polymer. The conductive polymer is configured to be doped and dedoped with anions. In the electrochemical device, the positive electrode active material is doped (at the time of charge) or dedoped (at the time of discharge) with anions, and cations are occluded (at the time of charge) or released (at the time of discharge) in the negative electrode active material. In this way, a capacitance of the electrochemical device can be obtained.

The reason why a float property of the electrochemical device decreases is considered to be an increase in internal resistance of a positive electrode during float charging. As the internal resistance increases, the voltage decreases to let the capacitance decrease. This decrease in capacitance means the decrease in float property. In general, the float property of an electrochemical device that contains a conductive polymer as a positive electrode active material tends to decrease.

In the electrochemical device, the conductive polymer is synthesized by electrolytic polymerization or chemical polymerization under a reaction solution containing a raw material monomer. As a solvent of the reaction solution, water is usually used. When water is used as a solvent of the reaction solution, large amount of water is incorporated into the conductive polymer. Thus, it is difficult to completely remove the water from the conductive polymer even when the conductive polymer is dried at a high temperature. For this reason, on the positive electrode side, a component contained in the electrolytic solution reacts with water in the electrolytic solution or water incorporated in the conductive polymer and is oxidatively decomposed. And this may lead to an increase in internal resistance.

when a conductive polymer synthesized by chemical polymerization is used, a binder is added to the conductive polymer in order to facilitate formation of an active layer containing a positive electrode active material by bonding powders of the conductive polymer to each other. Meanwhile, the addition of the binder increases the internal resistance on the positive electrode side. The binder covering the surface of the conductive polymer may disturb adsorption of the anion as a dopant, resulting in an increase in internal resistance.

On the other hand, when a conductive polymer synthesized by electrolytic polymerization is used, a binder is unnecessary. Meanwhile, sulfate ions (SO₄²⁻) contained in the reaction solution during electrolytic polymerization may slightly remain in the conductive polymer (for example, when the conductive polymer is a polyaniline, sulfate ions may remain in the conductive polymer at a concentration of less than or equal to 1000 ppm on a mass basis) or may be eluted into the electrolytic solution. In the positive electrode, the sulfate ions may cause a decomposition reaction of the positive electrode material (polyaniline or positive current collector) or the electrolytic solution. As a result, it is considered that the internal resistance increases, leading to a decrease in float property.

In the electrochemical device according to the present exemplary embodiment, the electrolytic solution contains (a) a first salt of a lithium ion and a first anion and (b) a second salt of a lithium ion and a second anion. The first anion is a bis(sulfonyl)imide anion containing fluorine. That is, the first salt is a lithium bis(sulfonyl)imide containing fluorine. The lithium bis(sulfonyl)imide containing fluorine is represented by LiN(SO₂R¹)(SO₂R²). R¹ and R² are each a fluorine group or an alkyl group containing fluorine. This suppresses a decrease in float property.

It is considered that the bis(sulfonyl)imide anion contained in the first salt mainly acts at the positive electrode and assists adsorption or desorption of the anion (second anion) at the positive electrode. As a result, it is considered that the internal resistance of the positive electrode decreases, and a decrease in float property is suppressed.

Among lithium bis(sulfonyl)imides containing fluorine, lithium bis(fluorosulfonyl)imide (LiN(SO₂F)₂) (hereinafter, also referred to as LIFSI) is preferable. When LIFSI is used as the first salt, the float property remarkably improves.

Further, when lithium hexafluorophosphate (LiPF₆) is contained as the second salt, remarkable improvement in float property is observed as compared with the case of using lithium tetrafluoroborate (LiBF₄) even though the diameter of the second anion is larger.

The concentration M of a total of the first anion and the second anion in the electrolytic solution may be more than 1.8 mol/L and less than or equal to 3 mol/L. The above-described range of the anion concentration is a value at the time of full discharge. Each anion concentration is determined by disassembling the electrochemical device in a fully discharged state and analyzing the extracted electrolytic solution by ion chromatography.

When the rated capacitance of the electrochemical device is C, the fully discharged state is a state in which the electrochemical device is discharged to a state of charge (SOC) of less than or equal to 0.05×C. For example, the fully discharged state means a state in which the electrochemical device is discharged to the lower limit voltage at a constant current of 0.05 C. The lower limit voltage is, for example, 2.5 V. On the other hand, a fully charged state is a state in which the electrochemical device is charged until the SOC reaches more than or equal to 0.98×C. For example, the fully charged state means a state in which the electrochemical device is discharged to the upper limit voltage at a constant current of 0.05 C thereafter charged at a constant voltage until the current value becomes less than or equal to 0.02 C at the upper limit voltage. The upper limit voltage is, for example, 3.6 V. The upper limit voltage and the lower limit voltage may be determined in consideration of the cycle characteristics of the electrochemical device such that a predetermined capacitance retention rate (for example, 80%) is guaranteed at a predetermined number of charge-discharge times (for example, 500 times). Meanwhile, the conditions of the charge-discharge method and the like including the upper limit voltage and the lower limit voltage are not limited to the conditions in the present disclosure. When these conditions are determined by specifications of a module including the electrochemical device or a system in which modules are combined, these conditions may be conditions adapted to these specifications.

When the amount of anions in the electrolytic solution is small, it is considered that the conductive polymer is hardly doped with anions although the anions move to the vicinity of the surface of the conductive polymer as the positive electrode active material during charging. Further, in the electrochemical device, the anions move to the positive electrode and lithium ions move to the negative electrode in accordance with charging. As a result, the salt concentration of the electrolytic solution may decrease in accordance with charging. However, by setting a concentration of the total of the first anion and the second anion to be more than 1.8 mol/L, the conductive polymer can be easily doped with the anions during charging and sufficient ionic conductivity of the electrolytic solution can be obtained even in a fully charged state.

On the other hand, when the salt concentration (anion concentration) is too high, the viscosity of the electrolytic solution increases, resulting in a decrease in ion conductivity. By setting a salt concentration of the total of the first anion and the second anion to be less than or equal to 3 mol/L, an increase in viscosity of the electrolytic solution can be suppressed and high ion conductivity of the electrolytic solution can maintain.

The concentration M may be more than 1.8 mol/L, and may be more than or equal to 1.9 mol/L, more than or equal to 2.0 mol/L, or more than or equal to 2.2 mol/L. The concentration M may be less than or equal to 3 mol/L, less than or equal to 2.5 mol/L, or less than or equal to 2.4 mol/L. The upper limits and the lower limits of the above concentration may have any combination. The concentration M may be, for example, more than 1.8 mol/L and less than or equal to 3 mol/L, more than 1.8 mol/L and less than or equal to 2.5 mol/L, from 1.9 mol/L to 2.5 mol/L, inclusive, or from 1.9 mol/L to 2.4 mol/L, inclusive.

The concentration A of the first anion in the electrolytic solution may be more than or equal to 0.05 mol/L. When the concentration A of the first anion is more than or equal to 0.05 mol/L, a sufficient effect of suppressing an increase in internal resistance of the positive electrode is obtained, and a decrease in float property is suppressed. The concentration A of the first anion may be less than or equal to 1.95 mol/L. From the viewpoint of suppressing the production cost, the concentration A of the first anion may be less than or equal to 1 mol/L.

The ratio B/A of the concentration B of the second anion to the concentration A of the first anion may range from 0.03 to 39, inclusive, from 0.05 to 19, inclusive, or from 0.1 to 9, inclusive.

The conductive polymer may include a polyaniline. The polyaniline refers to a polymer containing aniline (C₆H₅—NH₂) as a monomer and having an amine structural unit C₆H₄—NH—C₆H₄—NH— or an imine structural unit C₆H₄—N═C₆H₄═N—. Meanwhile, the polyaniline usable as the conductive polymer is not limited to these polymers. The polyaniline of the present invention includes, for example, a compound containing a benzene ring to a part of which an alkyl group such as a methyl group is attached and a derivative containing a benzene ring to a part of which a halogen group or the like is attached, as long as the compound and the derivative are polymers containing aniline as a basic skeleton. The conductive polymer may contain at least one of these polyanilines.

Further, as the conductive polymer that can be used together with polyaniline or alone, a π-conjugated polymer may be used. Examples of the π-conjugated polymer that can be used include polypyrrole, polythiophene, polyfuran, polythiophene vinylene, polypyridine, and derivatives of these polymers. The weight-average molecular weight of the conductive polymer is not particularly limited and ranges, for example, from 1000 to 100000, inclusive. Examples of a raw material monomer of the conductive polymer that can be used include pyrrole, thiophene, furan, thiophene vinylene, pyridine, and derivatives of these monomers. The raw material monomer may include an oligomer.

Derivatives of polypyrrole, polythiophene, polyfuran, polythiophene vinylene, and polypyridine mean polymers having, as a basic skeleton, polypyrrole, polythiophene, polyfuran, polythiophene vinylene, and polypyridine, respectively. For example, a polythiophene derivative includes poly(3,4-ethylenedioxythiophene) (PEDOT) and the like.

Further, the electrochemical device may contain SO₄²⁻ at a ratio of less than or equal to 1000 ppm with respect to the mass of the conductive polymer. Even when the conductor polymer is synthesized by electrolytic polymerization as a positive electrode active material, an effect of suppressing a decrease in float property can be obtained. SO₄²⁻ may be contained, for example, at a ratio of more than or equal to 10 ppm with respect to the mass of the conductive polymer synthesized by electrolytic polymerization (in the positive electrode active material or the electrolytic solution).

### <<Electrochemical Device>>

Hereinafter, a configuration of the electrochemical device according to the present invention will be described in more detail with reference to the drawing.

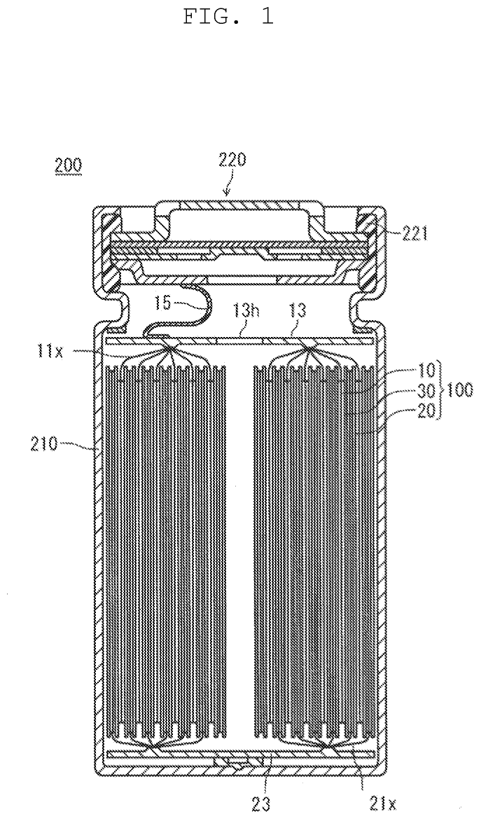

FIG. 1 is a longitudinal cross-sectional view illustrating an outline of a configuration of electrochemical device 200 according to one exemplary embodiment of the present invention. Electrochemical device 200 is provided with electrode body 100, a nonaqueous electrolytic solution (not shown), metallic bottomed cell case 210 housing electrode body 100 and the nonaqueous electrolytic solution, and sealing plate 220 sealing an opening of cell case 210.

Electrode body 100 is configured as a columnar wound body by, for example, winding a belt-shaped negative electrode and a belt-shaped positive electrode together with a separator interposed between them. Alternatively, electrode body 100 may also be formed as a stacked body in which a plate-like positive electrode and a plate-like negative electrode are stacked with a separator interposed between them. The positive electrode is provided with a positive electrode core material and a positive electrode material layer supported by the positive electrode core material. The negative electrode is provided with a negative electrode core material and a negative electrode material layer supported by the negative electrode core material.

Gasket 221 is provided on the peripheral edge of sealing plate 220, and the open end of cell case 210 is caulked by gasket 221, whereby the inside of cell case 210 is sealed. Positive electrode current collecting plate 13 having through hole 13h in the center is welded to positive-electrode-core-material exposed part 11x. The other end of tab lead 15 having one end connected to positive electrode current collecting plate 13 is connected to an inner surface of sealing plate 220. Thus, sealing plate 220 has a function as an external positive electrode terminal. On the other hand, negative electrode current collecting plate 23 is welded to negative-electrode-core-material exposed part 21x. Negative electrode current collecting plate 23 is directly welded to a welding member provided on the inner bottom surface of cell case 210. Thus, cell case 210 has a function as an external negative electrode terminal.

### (Positive Electrode Core Material)

A sheet-shaped metal material is used as the positive electrode core material. The sheet-shaped metal material may be a metal foil, a porous metal body, an etched metal, or the like. As the metal material, aluminum, aluminum alloy, nickel, titanium, or the like may be used. The thickness of the positive electrode core material ranges, for example, from 10 μm to 100 μm, inclusive. A carbon layer may be formed on the positive electrode core material. The carbon layer is interposed between the positive electrode core material and the positive electrode material layer, and has a function of, for example, reducing the resistance between the positive electrode core material and the positive electrode material layer and improving the current collecting property from the positive electrode material layer to the positive electrode core material.

### (Carbon Layer)

The carbon layer is formed, for example, by depositing a conductive carbon material on the surface of the positive electrode core material, or forming a coating film of a carbon paste containing a conductive carbon material, and drying the coating film. The carbon paste includes, for example, a conductive carbon material, a polymer material, and water or an organic solvent. The thickness of the carbon layer may ranges, for example, from 1 μm to 20 μm, inclusive. As the conductive carbon material, graphite, hard carbon, soft carbon, carbon black, or the like may be used. Among them, carbon black may form a thin carbon layer having excellent conductivity. As the polymer material, fluorine resin, acrylic resin, polyvinyl chloride, styrene-butadiene rubber (SBR), or the like may be used.

### (Positive Electrode Material Layer)

The positive electrode material layer contains a conductive polymer as a positive electrode active material. The positive electrode material layer is formed, for example, by immersing the positive electrode core material provided with the carbon layer in a reaction solution containing a raw material monomer of the conductive polymer, and electrolytically polymerizing the raw material monomer in the presence of the positive electrode core material. At this time, by performing electrolytic polymerization with the positive electrode core material as an anode, the positive electrode material layer containing the conductive polymer is formed so as to cover the carbon layer. The thickness of the positive electrode material layer may be controlled by the electrolytic current density, the polymerization time, and the like. The thickness of the positive electrode material layer ranges, for example, from 10 μm to 300 μm, inclusive, per surface. The weight-average molecular weight of the conductive polymer is not particularly limited and ranges, for example, from 1000 to 100000, inclusive.

The positive electrode material layer may be formed by a method other than electrolytic polymerization. For example, the positive electrode material layer containing a conductive polymer may be formed by chemical polymerization of a raw material monomer. The positive electrode material layer may also be formed by using a conductive polymer synthesized in advance or a dispersion thereof.

The raw material monomer used in electrolytic polymerization or chemical polymerization may be any polymerizable compound capable of producing a conductive polymer by polymerization. The raw material monomer may contain an oligomer. Examples of the raw material monomer that can be used include aniline, pyrrole, thiophene, furan, thiophene vinylene, pyridine, and derivatives of these monomers. These materials may be used alone or in combination of two or more thereof. Among them, aniline easily grows on the surface of the carbon layer by electrolytic polymerization.

When the positive electrode material layer contains a polyaniline as a conductive polymer, the proportion of the polyaniline to all conductive polymers constituting the positive electrode material layer may be more than or equal to 90 mass %.

Electrolytic polymerization or chemical polymerization may be carried out with a reaction solution containing a dopant. A π-electron conjugated polymer doped with a dopant exhibits excellent conductivity. For example, in chemical polymerization, the positive electrode core material may be immersed in a reaction solution containing a dopant, an oxidizing agent, and a raw material monomer, and then, withdrawn from the reaction solution and dried. In the electrolytic polymerization, the positive electrode core material and a counter electrode may be immersed in a reaction solution containing a dopant and a raw material monomer, and a current may flow between the positive electrode core material as an anode and the counter electrode as a cathode.

As the solvent of the reaction solution, water may be used, or a nonaqueous solvent may be used in consideration of solubility of the monomer. As the nonaqueous solvent, it is preferable to use alcohols and the like such as ethyl alcohol, methyl alcohol, isopropyl alcohol, ethylene glycol, and propylene glycol. Examples of a dispersion medium or solvent of the conductive polymer include water and the nonaqueous solvents described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃—), a perchlorate ion (ClO₄—), a tetrafluoroborate ion (BF₄—), a hexafluorophosphate ion (PF₆—), a fluorosulfate ion (FSO₃—), a bis(fluorosulfonyl)imide ion (N(FSO₂)₂—), and a bis(trifluoromethanesulfonyl)imide ion (N(CF₃SO₂)₂—). These may be used alone or in combination of two or more thereof.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be a homopolymer or a copolymer of two or more monomers. These may be used alone or in combination of two or more thereof.

### (Positive Electrode Current Collecting Plate)

The positive electrode current collecting plate is a metal plate having a substantially disk shape. It is preferable to form a through hole serving as a passage for the nonaqueous electrolyte in the central part of the positive electrode current collecting plate. The material of the positive electrode current collecting plate is, for example, aluminum, aluminum alloy, titanium, stainless steel, or the like. The material of the positive electrode current collecting plate may be the same as the material of the positive electrode core material.

### (Negative Electrode Core Material)

A sheet-shaped metal material is also used for the negative electrode core material. The sheet-shaped metal material may be a metal foil, a porous metal body, an etched metal, or the like. As the metal material, copper, copper alloy, nickel, stainless steel, or the like may be used. The thickness of the negative electrode core material ranges, for example, from 10 μm to 100 μm, inclusive.

### (Negative Electrode Material Layer)

The negative electrode material layer includes a material that electrochemically absorbs and releases lithium ions as a negative electrode active material. Examples of such a material include a carbon material, a metal compound, an alloy, and a ceramic material. As the carbon material, graphite, hardly-graphitizable carbon (hard carbon), and easily-graphitizable carbon (soft carbon) are preferable, and graphite and hard carbon are particularly preferable. Examples of the metal compound include silicon oxides and tin oxides. Examples of the alloy include silicon alloys and tin alloys. Examples of the ceramic material include lithium titanate and lithium manganate. These may be used alone or in combination of two or more thereof. Among these materials, a carbon material is preferable in terms of being capable of decreasing a potential of the negative electrode.

The negative electrode material layer may contain a conductive agent, a binder, and the like in addition to the negative electrode active material. Examples of the conductive agent include carbon black and carbon fiber. Examples of the binder include a fluorine resin, an acrylic resin, a rubber material, and a cellulose derivative.

The negative electrode material layer is formed by, for example, mixing the negative electrode active material, the conductive agent, the binder, and the like with a dispersion medium to prepare a negative electrode mixture paste, and applying the negative electrode mixture paste to the negative electrode core material and then drying the negative electrode mixture paste. The thickness of the negative electrode material layer ranges, for example, from 10 μm to 300 μm, inclusive, per surface.

The negative electrode material layer is preferably pre-doped with lithium ions in advance. This decreases the potential of the negative electrode and thus increases a difference in potential (that is, voltage) between the positive electrode and the negative electrode and improves energy density of the electrochemical device.

Pre-doping of the negative electrode with the lithium ions is progressed by, for example, forming a metallic lithium layer that is to serve as a supply source of lithium ions on a surface of the negative electrode material layer and impregnating the negative electrode including the metallic lithium layer with an electrolytic solution (for example, a nonaqueous electrolytic solution) having lithium ion conductivity. At this time, lithium ions are eluted from the metallic lithium layer into the nonaqueous electrolytic solution, and the eluted lithium ions are occluded in the negative electrode active material. For example, when graphite or hard carbon is used as the negative electrode active material, lithium ions are inserted in between layers of graphite or in fine pores of hard carbon. The amount of lithium ions for the pre-doping may be controlled by the mass of the metallic lithium layer. The amount of lithium for the pre-doping may range, for example, approximately from 50% to 95%, inclusive, with respect to the maximum amount that can be occluded in the negative electrode material layer.

The step of pre-doping the negative electrode with lithium ions may be performed before the electrode group is assembled, or the pre-doping may be progressed after the electrode group is housed in a case of the electrochemical device together with the nonaqueous electrolytic solution.

### (Negative Electrode Current Collecting Plate)

The negative electrode current collecting plate is a metal plate having a substantially disk shape. The material of the negative electrode current collecting plate is, for example, copper, copper alloy, nickel, stainless steel, or the like. The material of the negative electrode current collecting plate may be the same as the material of the negative electrode core material.

### (Separator)

As the separator, a non-woven fabric made of cellulose fiber, a non-woven fabric made of glass fiber, a microporous film made of polyolefin, a woven fabric, a non-woven fabric, or the like may be used. The thickness of the separator ranges, for example, from 10 μm to 300 μm, inclusive, preferably from 10 μm to 40 μm, inclusive.

### (Electrolytic Solution)

The electrolytic solution contains a first salt of a lithium ion and a first anion, a second salt of a lithium ion and a second anion, and a solvent for dissolving the first salt and the second salt. The first salt contains a lithium bis(sulfonyl)imide. At this time, the first anion (here, FSI anion) and the second anion can be repeatedly reversibly doped into and dedoped from the positive electrode. The lithium ions can be reversibly occluded into and released from the negative electrode.

Examples of the lithium salt constituting the second salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, and LiBCl₄. These may be used alone or in combination of two or more thereof. Among these, it is preferable to use at least one selected from lithium salts having an oxoacid anion containing a halogen atom suitable as an anion.

The solvent may be a nonaqueous solvent. Examples of the nonaqueous solvent that can be used include cyclic carbonates such as ethylene carbonate, propylene carbonate, and butylene carbonate, chain carbonates such as dimethyl carbonate, diethyl carbonate, and ethyl methyl carbonate, aliphatic carboxylic acid esters such as methyl formate, methyl acetate, methyl propionate, and ethyl propionate, lactones such as γ-butyrolactone and γ-valerolactone, chain ethers such as 1,2-dimethoxyethane (DME), 1,2-diethoxyethane (DEE), and ethoxymethoxyethane (EME), cyclic ethers such as tetrahydrofuran and 2-methyltetrahydrofuran, dimethylsulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-prop anesultone. These may be used alone or in combination of two or more thereof.

The nonaqueous electrolytic solution may contain an additive agent in the nonaqueous solvent as necessary. For example, an unsaturated carbonate such as vinylene carbonate, vinyl ethylene carbonate, or divinyl ethylene carbonate may be added as an additive for forming a coating having high lithium ion conductivity (coating film formation agent) on the surface of the negative electrode.

The nonaqueous solvent may be, for example, γ-butyrolactone (GBL). Since GBL has a high oxidation resistance, the reaction with water is suppressed, and an increase in the internal resistance is easily suppressed even when water is incorporated into the conductive polymer. Further, GBL has a low melting point and has high ion conductivity even at a low temperature, and thus allows the electrochemical device to maintain a low internal resistance even when the device is used in a low-temperature environment.

Meanwhile, when γ-butyrolactone (GBL) is used as the nonaqueous solvent, it is preferred that the above-described coating film formation agent be added to the electrolytic solution to form a uniform and dense solid electrolyte interface on the surface of the negative electrode active material, because GBL easily undergoes reductive decomposition on the negative electrode side. This enables an electrochemical device excellent in float property to be obtained in which an increase in internal resistance is synergistically suppressed.

The proportion of γ-butyrolactone in the whole electrolytic solution is, for example, more than or equal to 50 mass %, more than or equal to 60 mass %, more than or equal to 70 mass %, more than or equal to 90 mass %, or more than or equal to 95 mass %.

The nonaqueous solvent may contain ethylene carbonate (EC) or methyl propionate (MP). Adding EC or MP to the nonaqueous solvent of the electrolytic solution can also reduce the initial resistance and improve float property. In addition, ethylene carbonate has a high specific inductive capacitance and thus can increase, on the positive electrode side, performance of the electrochemical device having a property as a capacitor as well. Further, ethylene carbonate has a high flash point and thus can enhance safety in liquid leakage. Adding methyl propionate can suppress a decrease in performance in a low-temperature environment.

The electrolytic solution may also contain, as an additive, at least one selected from the group consisting of an alkyl sulfuric acid ester anion represented by [R³—O—SO₃]⁻ where R³ is an alkyl group having 1 to 5 carbon atoms, a fluorophosphoric acid anion represented by [POₓF_{y}]^{5-2x-y} where x and y are integers satisfying x≥1 and y≥1 respectively and satisfying 1≤2x+y−5≤3, and a bidentate ligand containing complex anion in which two carboxylate ions (COO⁻) of a dicarboxylic acid are coordinate-bonded to boron (B) or phosphorus (P).

In the above-described exemplary embodiment, a wound electrochemical device having a cylindrical shape has been described. The scope of application of the present invention is not limited to the exemplary embodiment described above, and the present invention is also applicable to a wound or laminated electrochemical device having a rectangular shape.

### EXAMPLES

Hereinafter, the present invention will be described in more detail with reference to Examples. The present invention is not limited to Examples.

### <<Electrochemical Devices A1 to A22>>

### (1) Production of Positive Electrode

An aluminum foil having a thickness of 30 μm was prepared as a positive current collector. An aqueous aniline solution containing aniline and sulfuric acid was prepared.

A carbon paste obtained by kneading carbon black with water was applied to an entirety of front and back surfaces of the positive current collector and then dried by heating to form a carbon layer. The carbon layer had a thickness of 2 μm per surface.

The positive current collector on which the carbon layer was formed and a counter electrode were immersed in the aqueous aniline solution containing sulfuric acid, and electrolytic polymerization was performed at a current density of 10 mA/cm² for 20 minutes to attach a film of a conductive polymer (polyaniline) doped with sulfate ions (SO₄²⁻) onto the carbon layer on each of the front and back surfaces of the positive current collector.

The conductive polymer doped with sulfate ions was reduced so that some of the sulfate ions were dedoped from the conductive polymer. In this way, an active layer containing the conductive polymer from which the sulfate ions were dedoped was formed. Next, the active layer was thoroughly washed and then dried. The active layer had a thickness of 35 μm per surface.

### (2) Production of Negative Electrode

A copper foil having a thickness of 20 μm was prepared as a negative current collector. A negative electrode mixture paste was prepared by kneading a mixed powder with water at a weight ratio of 40:60. The mixed powder contained 97 parts by mass of hard carbon, 1 part by mass of carboxy cellulose, and 2 parts by mass of styrene-butadiene rubber. The negative electrode mixture paste was applied to both surfaces of the negative current collector and dried to obtain a negative electrode having a negative electrode material layer having a thickness of 35 μm on each of the both surfaces. Next, a metallic lithium foil was attached to the negative electrode material layer. An amount of the metallic lithium foil was calculated such that a potential of the negative electrode after completion of pre-doping was less than or equal to 0.2 V with respect to the potential of metallic lithium in an electrolytic solution.

### (3) Production of Electrode Group

Lead tabs were respectively connected to the positive electrode and the negative electrode, and then, as shown in FIG. 3, a stacked body in which a nonwoven fabric separator (thickness 35 μm) made of cellulose, and the positive electrode and the negative electrode are alternately stacked each other was wound to form an electrode group.

### (4) Preparation of Nonaqueous Electrolytic Solution

To a mixture of propylene carbonate (PC) and dimethyl carbonate (DMC) at a volume ratio of 1:1, vinylene carbonate (VC) was added in an amount of 3.0 parts by mass with respect to 100 parts by mass of the mixture to prepare a solvent. The first salt and the second salt were dissolved in the obtained solvent at predetermined concentrations shown in Table 1 to prepare a nonaqueous electrolytic solution.

### (5) Production of Electrochemical Device

The electrode group and the nonaqueous electrolytic solution were housed in a bottomed container having an opening. In this way, an electrochemical device as shown in FIG. 2 was assembled. Thereafter, aging was performed by applying a charge voltage of 3.8 V between terminals of the positive electrode and the negative electrode at 25° C. for 24 hours, to progress pre-doping of the negative electrode with lithium ions. In this way, electrochemical devices A1 to A 22 having different compositions of the nonaqueous electrolytic solution were prepared.

### <<Electrochemical Device B1>>

In the preparation of the nonaqueous electrolytic solution, the first salt (lithium bis(sulfonyl)imide) was not added, and only LiPF₆ as a lithium salt was dissolved in the solvent at a concentration of 2 mol/L to prepare a nonaqueous electrolytic solution. Except for the above, electrochemical device B1 was produced in the same manner as electrochemical devices A1 to A22.

### <<Electrochemical Device B2>>

In the preparation of the nonaqueous electrolytic solution, the first salt (lithium bis(sulfonyl)imide) was not added, and LiPF₆ and LiBF₄ as lithium salts were dissolved in the solvent each at a concentration of 1 mol/L to prepare a nonaqueous electrolytic solution. Except for the above, electrochemical device B2 was produced in the same manner as electrochemical devices A1 to A22.

TABLE 1

| | Anion of first salt | | Anion of second salt | | Total of first salt | |
|---|---|---|---|---|---|---|
| | | Addition | | Addition | and second salt | |
| | Anion | amount A | Anion | amount B | M (=A + B) | |
| | species | [mol/L] | species | [mol/L] | [mol/L] | B/A |
| Al | (FSO₂)₂N⁻ | 0.425 | PF₆⁻ | 1.275 | 1.7 | 3 |
| A2 | (FSO₂)₂N⁻ | 0.45 | PF₆⁻ | 1.35 | 1.8 | 3 |
| A3 | (FSO₂)₂N⁻ | 0.46 | PF₆⁻ | 1.39 | 1.85 | 3 |
| A4 | (FSO₂)₂N⁻ | 1.95 | PF₆⁻ | 0.05 | 2 | 0.03 |
| A5 | (FSO₂)₂N⁻ | 1.9 | PF₆⁻ | 0.1 | 2 | 0.05 |
| A6 | (FSO₂)₂N⁻ | 1.8 | PF₆⁻ | 0.2 | 2 | 0.11 |
| A7 | (FSO₂)₂N⁻ | 1.5 | PF₆⁻ | 0.5 | 2 | 0.33 |
| A8 | (FSO₂)₂N⁻ | 1.3 | PF₆⁻ | 0.7 | 2 | 0.54 |
| A9 | (FSO₂)₂N⁻ | 1.1 | PF₆⁻ | 0.9 | 2 | 0.82 |
| A10 | (FSO₂)₂N⁻ | 1 | PF₆⁻ | 1 | 2 | 1 |
| A11 | (FSO₂)₂N⁻ | 0.7 | PF₆⁻ | 1.3 | 2 | 1.86 |
| A12 | (FSO₂)₂N⁻ | 0.5 | PF₆⁻ | 1.5 | 2 | 3 |
| A13 | (FSO₂)₂N⁻ | 0.3 | PF₆⁻ | 1.7 | 2 | 5.67 |
| A14 | (FSO₂)₂N⁻ | 0.2 | PF₆⁻ | 1.8 | 2 | 9 |
| A15 | (FSO₂)₂N⁻ | 0.1 | PF₆⁻ | 1.9 | 2 | 19 |
| A16 | (FSO₂)₂N⁻ | 0.05 | PF₆⁻ | 1.95 | 2 | 39 |
| A17 | (FSO₂)₂N⁻ | 0.55 | PF₆⁻ | 1.65 | 2.2 | 3 |
| A18 | (FSO₂)₂N⁻ | 0.6 | PF₆⁻ | 1.8 | 2.4 | 3 |
| A19 | (FSO₂)₂N⁻ | 0.625 | PF₆⁻ | 1.875 | 2.5 | 3 |
| A20 | (FSO₂)₂N⁻ | 0.5 | BF₄⁻ | 1.5 | 2 | 3 |
| A21 | (C₂F₅SO₂)₂N⁻ | 0.5 | PF₆⁻ | 1.5 | 2 | 3 |
| A22 | (CF₃SO₂)₂N⁻ | 0.5 | PF₆⁻ | 1.5 | 2 | 3 |
| B1 | — | — | PF₆⁻ | 2 | 2 | — |
| B2 | BF₄⁻ | 1 | PF₆⁻ | 1 | 2 | 1 |

Table 1 shows the anion species of the lithium salts added as the first salt and the second salt, the addition amount A of the first salt, the addition amount B of the second salt, the total A+B of the addition amounts of the first salt and the second salt, and the ratio B/A of the addition amounts in electrochemical devices A1 to A 22 and B1 and B2. As shown in Table 1, in electrochemical devices A21 and A22, lithium bis(pentafluoroethanesulfonyl)imide (LiN(SO₂C₂F₅)₂) or lithium bis(trifluoromethanesulfonyl)imide (LiN(SO₂CF₃)₂) was used as the first salt instead of LIFSI (LiN(SO₂F)₂).

The obtained electrochemical devices A1 to A22 and B1 and B2 were evaluated according to the following methods.

### (Evaluation Method)

### (1) Internal Resistance (DCR)

An initial internal resistance (initial DCR) was obtained from the relationship between the voltage drop and the discharge current when the electrochemical devices were discharged for a predetermined time after being charged at a voltage of 3.6 V. The initial internal resistance for each of the electrochemical devices was expressed as a relative value with the initial internal resistance of electrochemical device B1 defined as 100. Table 2 shows evaluation results. Table 2 shows the relative values with the initial internal resistance of the electrochemical device B1 defined as 100.

### (2) Float Property

After the electrochemical devices were continuously charged under the conditions of 60° C. and 3.6 V for 1000 hours, a resistance value of each of the electrochemical devices was measured. And a change rate of the resistance value with respect to a (initial) resistance value before the continuous charging was calculated. The change rate was determined by (resistance value after 1000-hour charge/initial resistance value)×100. The smaller the change rate in the resistance value, the more the decline in float property is suppressed. Table 2 shows evaluation results. Table 2 shows relative values of the change rates in resistance values of the electrochemical devices with the change rate in resistance value of electrochemical device B1 defined as 100.

TABLE 2

| | Initial DCR | Float property |
|---|---|---|
| A1 | 87.1 | 76.1 |
| A2 | 85.1 | 74.1 |
| A3 | 77.8 | 72.0 |
| A4 | 88.9 | 69.2 |
| A5 | 85.2 | 69.0 |
| A6 | 84.6 | 67.0 |
| A7 | 83.6 | 66.4 |
| A8 | 82.1 | 66.3 |
| A9 | 81.6 | 65.9 |
| A10 | 79.1 | 65.4 |
| A11 | 78.2 | 65.4 |
| A12 | 75.6 | 65.0 |
| A13 | 78.8 | 65.3 |
| A14 | 85.6 | 65.9 |
| A15 | 88.9 | 68.2 |
| A16 | 92.3 | 68.6 |
| A17 | 79.2 | 69.9 |
| A18 | 81.3 | 71.2 |
| A19 | 88.4 | 74.6 |
| A20 | 95.3 | 78.3 |
| A21 | 98.2 | 97.6 |
| A22 | 99.3 | 95.0 |
| B1 | 100 | 100 |
| B2 | 121.5 | 99.5 |

### <<Electrochemical Devices A23, A24, B3>>

In the preparation of the nonaqueous electrolytic solution, vinylene carbonate (VC) was added to γ-butyrolactone (GBL) to prepare a solvent. A ratio of VC was 3.0 parts by mass with respect to 100 parts by mass of GBL. The first salt and the second salt were dissolved in the obtained solvent at predetermined concentrations shown in Table 3 to prepare a nonaqueous electrolytic solution. Except for the above, an electrochemical device was produced and evaluated in the same manner as electrochemical devices A1 to A22. Table 4 shows the evaluation results. Table 4 shows relative values of initial DCR with the initial internal resistance of electrochemical device B3 defined as 100. Table 4 also shows relative values of the float property with the change rate in resistance of electrochemical device B3 defined as 100.

### <<Electrochemical Devices A25, A26, B4>>

In the preparation of the nonaqueous electrolytic solution, vinylene carbonate (VC) was added to a mixture of propylene carbonate (PC), ethylene carbonate (EC), dimethyl carbonate (DMC), and methyl propionate (MP) to prepare a solvent. PC, EC, DMC, and MP are mixed in the mixture at a volume ratio of 2:3:3:2, and a ratio of VC was 3.0 parts by mass with respect to 100 parts by mass of the mixture. The first salt and the second salt were dissolved in the obtained solvent at predetermined concentrations shown in Table 3 to prepare a nonaqueous electrolytic solution. Except for the above, an electrochemical device was produced and evaluated in the same manner as electrochemical devices A1 to A22. Table 5 shows the evaluation results. Table 5 shows relative values of initial DCR with the initial internal resistance of electrochemical device B4 defined as 100. Table 5 shows relative values of the float property with the change rate in resistance of the electrochemical device B4 defined as 100.

TABLE 3

| | Anion of first salt | | Anion of second salt | | Total of first salt | |
|---|---|---|---|---|---|---|
| | | Addition | | Addition | and second salt | |
| | Anion | amount A | Anion | amount B | M (=A + B) | |
| | species | [mol/L] | species | [mol/L] | [mol/L] | B/A |
| A23 | (FSO₂)₂N⁻ | 0.5 | PF₆⁻ | 1.5 | 2 | 3 |
| A24 | (FSO₂)₂N⁻ | 0.05 | PF₆⁻ | 1.95 | 2 | 39 |
| B3 | — | — | PF₆⁻ | 2 | 2 | — |
| A25 | (FSO₂)₂N⁻ | 0.5 | PF₆⁻ | 1.5 | 2 | 3 |
| A26 | (FSO₂)₂N⁻ | 0.05 | PF₆⁻ | 1.95 | 2 | 39 |
| B4 | — | — | PF₆⁻ | 2 | 2 | — |

TABLE 4

| | Initial DCR | Float property |
|---|---|---|
| A23 | 78.3 | 67.0 |
| A24 | 89.7 | 69.8 |
| B3 | 100 | 100 |

TABLE 5

| | Initial DCR | Float property |
|---|---|---|
| A25 | 74.5 | 66.2 |
| A26 | 86.9 | 70.6 |
| B4 | 100 | 100 |

As shown in Table 2, in electrochemical devices A1 to A22 to which a lithium bis(sulfonyl)imide was added as the first salt, the initial DCR decreased and the decrease in float property was suppressed as compared with those of electrochemical devices B1 and B2 to which a lithium bis(sulfonyl)imide was not added.

Comparing the evaluation results in electrochemical devices A12, A21, and A22, electrochemical device A12 in which LIFSI is added as the first salt has a remarkable effect of improving initial DCR and float property as compared with electrochemical devices A21 and A22 in which the same amount of lithium bis(pentafluoroethanesulfonyl)imide or lithium bis(trifluoromethanesulfonyl)imide is added to the electrolytic solution.

Comparing the evaluation results in electrochemical devices A12 and A20, electrochemical device A12 including LiPF₆ as the second salt has a remarkable effect of improving initial DCR and float property by addition of LIFSI as compared with electrochemical device A20 including LiBF₄ as the second salt.

As shown in Tables 4 and 5, electrochemical devices A23, A24 including a solvent containing γ-butyrolactone (GBL) in the electrolytic solution and electrochemical devices A25, A26 including a solvent containing ethylene carbonate (EC) and methyl propionate (MP) in the electrolytic solution also have a remarkable effect of improving initial DCR and float characteristics by addition of a lithium bis(sulfonyl)imide.

### INDUSTRIAL APPLICABILITY

An electrochemical device according to the present invention has an excellent float property and is thus suitable as various electrochemical devices, particularly as a back-up power source.

### REFERENCE MARKS IN THE DRAWING

100: electrode body
10: positive electrode
11x: positive-electrode-core-material exposed part
13: positive electrode current collecting plate
15: tab lead
20: negative electrode
21x: negative-electrode-core-material exposed part
23: negative electrode current collecting plate
30: separator
200: electrochemical device
210: cell case
220: sealing plate
221: gasket

1. An electrochemical device comprising:
a positive electrode including a positive electrode active material;
a negative electrode including a negative electrode active material; and
an electrolytic solution, wherein:
the positive electrode active material contains a conductive polymer,
the conductive polymer is configured to be doped and dedoped with anions,
the electrolytic solution contains (a) a first salt of a lithium ion and a first anion and (b) a second salt of a lithium ion and a second anion, and
the first anion is a bis(sulfonyl)imide anion containing fluorine.

2. The electrochemical device according to claim 1, wherein the first salt is lithium bis(fluorosulfonyl)imide.

3. The electrochemical device according to claim 1, wherein the second salt includes lithium hexafluorophosphate.

4. The electrochemical device according to claim 1, wherein a concentration M of a total of the first anion and the second anion in the electrolytic solution is more than 1.8 mol/L and less than or equal to 3 mol/L.

5. The electrochemical device according to claim 1, wherein a concentration A of the first anion in the electrolytic solution is more than or equal to 0.05 mol/L and less than or equal to 1 mol/L.

6. The electrochemical device according to claim 1, wherein the conductive polymer includes a polyaniline.

7. The electrochemical device according to claim 1, wherein SO₄²⁻ is contained in the electrochemical device at a mass ratio of less than or equal to 1000 ppm with respect to a mass of the conductive polymer.
